(19) United States
(12) Patent Application Publication
(10) Pub. No.: US 2015/0363089 A1
(43) Pub. Date: Dec. 17, 2015

(54) INFORMATION ACQUIRING APPARATUS AND METHOD, AND ELECTRONIC DEVICE

(71) Applicant: Sony Corporation, Toyko (JP)

(72) Inventors: Xingyuan RAO, Beijing (CN); Dahai LIU, Beijing (CN); Hui LI, Beijing (CN)

(21) Appl. No.: 14/587,480

(22) Filed: Dec. 31, 2014

(30) Foreign Application Priority Data
Jun. 17, 2014 (CN) 201410270133.0

(51) Int. Cl. G06F 3/0484

(52) U.S. Cl. CPC G06F 3/04847; G06F 3/04842

(57) ABSTRACT

The embodiments of the present invention provide an information acquiring apparatus and method, and an electronic device, wherein the apparatus includes: a display control unit configured to control, according to a currently run application, to display operation options corresponding to the application; and a processing unit configured to process currently displayed information in response to a selected operation option, to acquire information related to the currently displayed information. Since the operation options are directly provided according to the application, and the information related to the currently displayed information is provided in response to the selected operation option, it is unnecessary to embed plugins into respective applications, thus required information can be acquired simply and conveniently.

### PRIORITY CLAIM AND INCORPORATION BY REFERENCE

Priority is claimed from Chinese patent application No. 201410270133.0, filed Jun. 17, 2014, the entire disclosure of which hereby is incorporated by reference.

### TECHNICAL FIELD

The present invention relates to the field of communications, and particularly to an information acquiring apparatus and method, and an electronic device.

### BACKGROUND

Currently, with the development of the communication technology, electronic devices such as mobile phone and tablet PC are widely used. In the mobile phone and tablet PC, various applications are increasingly rich, and the user also wants to acquire more related information when experiencing various applications. For example, when a song is played, the user may want to acquire related information of the singer of the song, such as an introduction and photos of the singer. For another example, when a short message containing English content is received, the English content needs to be translated.

### SUMMARY

The inventor of the present invention finds that the existing method has following problems: since plugins are embedded into respective applications to provide more information extension functions in the existing methods, each application shall be embedded with plugin(s), while some Application Programming Interfaces (APIs) are not open and corresponding plugins cannot be embedded, thus the cost is high and the usage is inconvenient.

The embodiments of the present invention provide an information acquiring apparatus and method, and an electronic device. Since operation options are directly provided according to an application, and information related to currently displayed information is provided in response to a selected operation option, it is unnecessary to embed plugins into respective applications, thus required information can be acquired simply and conveniently.

According to a first aspect of embodiments of the present invention, an information acquiring apparatus is provided, including: a display control unit configured to control, according to a currently run application, to display operation options corresponding to the application; and a processing unit configured to process currently displayed information in response to a selected operation option, to acquire information related to the currently displayed information.

According to a second aspect of embodiments of the present invention, an electronic device is provided, including an information acquiring apparatus according to the first aspect of the embodiments of the present invention.

According to a third aspect of embodiments of the present invention, an information acquiring method is provided, including: controlling, according to a currently run application, to display operation options corresponding to the application; and processing currently displayed information in response to a selected operation option, to acquire information related to the currently displayed information.

The embodiments of the present invention have following beneficial effects: since operation options are directly provided according to an application, and information related to currently displayed information is provided in response to a selected operation option, it is unnecessary to embed plugins into respective applications, thus required information can be acquired simply and conveniently.

With reference to the subsequent descriptions and drawings, embodiments of the present invention are specifically disclosed to indicate the implementations of principles of the present invention. It shall be appreciated that the scope of the embodiments of the present invention is not limited thereto, and they include many changes, modifications and equivalents falling within the scope of the spirit and the clauses of the accompanying claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

### BRIEF DESCRIPTION OF THE DRAWINGS

Many aspects of the present invention can be understood better with reference to the following drawings. The components in the drawings are not drafted in proportion, but just for illustrating principles of the present invention. For the convenience of illustrating and describing some portions of the present invention, corresponding portions in the drawings may be zoomed in or out. The elements and features illustrated in one drawing or embodiment of the present invention may be combined with the elements and features illustrated in one or more other drawings or embodiments. In addition, the similar reference signs denote corresponding parts throughout the drawings, and they can be used to denote corresponding parts in more than one embodiment.

FIG. 1 is a structure diagram of an information acquiring apparatus according to Embodiment 1 of the present invention;

FIG. 2 is a structure diagram of a processing unit according to Embodiment 1 of the present invention;

FIG. 3 is a flowchart of a method for processing the currently displayed information by the processing unit according to Embodiment 1 of the present invention;

FIG. 4 is a structure diagram of an identifying unit 103 according to Embodiment 1 of the present invention;

FIG. 5 is a flowchart of a method for identifying the currently displayed information and the currently run application by the identifying unit 103 according to Embodiment 1 of the present invention;

FIG. 6 is another structure diagram of the identifying unit 103 according to Embodiment 1 of the present invention;

FIG. 7 is another flowchart of a method for identifying the currently displayed information and the currently run application by the identifying unit 103 according to Embodiment 1 of the present invention;

FIG. 8 is a structure diagram of an electronic device according to Embodiment 2 of the present invention;

FIG. 9 is a block diagram of a system construction of the electronic device according to Embodiment 2 of the present invention; and

FIG. 10 is a flowchart of an information acquiring method according to Embodiment 3 of the present invention.

### DESCRIPTION OF THE EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present invention are mainly described with respect to a portable electronic apparatus in the form of a mobile phone (also referred to as “cellular phone”). However, it shall be appreciated that the present invention is not limited to the case of the mobile phone and it may relate to any type of appropriate electronic device, such as tablet PC, smart watch, smart glasses, smart wig, head-mounted device, wearable device, fixed-line telephone, media player, gaming device, PDA, computer, digital camera, etc.

Embodiments of the present invention provide an information acquiring apparatus and method, and an electronic device, wherein the apparatus includes: a display control unit configured to control, according to a currently run application, to display operation options corresponding to the application; and a processing unit configured to process currently displayed information in response to a selected operation option, to acquire information related to the currently displayed information. Since the operation options are directly provided according to the application, and the information related to the currently displayed information is provided in response to the selected operation option, it is unnecessary to embed plugins into respective applications, thus required information can be acquired simply and conveniently.

Next, the preferred embodiments of the present invention will be described with reference to the drawings.

### Embodiment 1

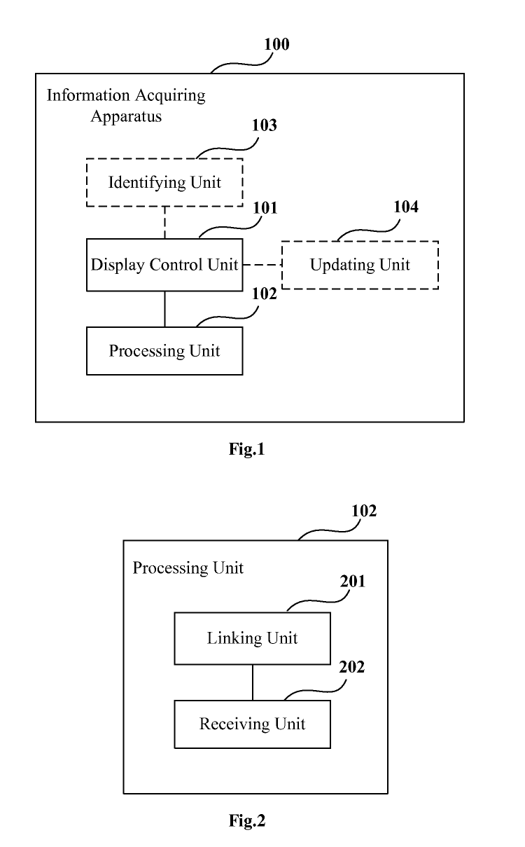

The embodiments of the present invention provide an information acquiring apparatus, and FIG. 1 is a structure diagram of the information acquiring apparatus. As illustrated in FIG. 1, the information acquiring apparatus 100 includes: a display control unit 101 and a processing unit 102. The display control unit 101 is configured to control, according to a currently run application, to display operation options corresponding to the application. The processing unit 102 is configured to process currently displayed information in response to a selected operation option, to acquire information related to the currently displayed information.

As can be seen from the above embodiment, since the operation options are directly provided according to the application, and the information related to the currently displayed information is provided in response to the selected operation option, it is unnecessary to embed plugins into respective applications; thus, required information can be acquired simply and conveniently.

In this embodiment, the currently run application may be of any type, such as multimedia player, short message or phone book.

In this embodiment, any of the existing methods may be adopted to acquire the currently run application and the currently displayed information. For example, the currently run application and the currently displayed information may be acquired through a control unit (e.g., CPU) that controls the application running and the information display, or by disposing a dedicated identifying unit for identifying the currently run application and the currently displayed information.

In this embodiment, the display control unit 101 controls, according to the currently run application, to display operation options corresponding to the application. Controlling to display the operation options corresponding to the application may be displaying the operation options corresponding to the application in response to the user's instruction, or automatically displaying the operation options corresponding to the application. The specific display mode is not limited in embodiments of the present invention.

In this embodiment, the operation options corresponding to the application for example are the related information options wanted by the user who uses the application, and it may be set upon the actual demand. The specific form and type of the operation options are not limited in embodiments of the present invention.

For example, in a case where the currently run application is a multimedia player, it plays multimedia files such as songs, movies or TV series, and the operation options corresponding to the application may include: lyrics, information of singer or actor, photos of singer or actor, issue date, etc.

For example, in a case where the currently run application is a short message, the operation options corresponding to the application may include: translate, search, etc.

For example, in a case where the currently run application is a phone book, the operation options corresponding to the application may include: search, call record, short message record, etc.

In this embodiment, when the operation options corresponding to the application are to be set, respective operation options may be set for different types of applications. For example, different targeted operation options may be set for the applications of multimedia entertainment type and the applications of communication type, respectively.

In this embodiment, highly referential operation options may be provided to the user according to a result of big data statistics. For example, the frequencies of operation options used by a large number of users may be counted, so as to provide operation options of high use frequencies. For another example, statistics may be performed according to users of different countries and regions, respectively, so as to provide operation options better meeting the use habits of the local people.

In this embodiment, personalized operation options also may be provided according to the user's state. For example, when the user is moving, the operation options with processed results beneficial to the user's viewing may be provided, such as the operation options of related audios, videos or pictures, wherein the user's state can be detected with any of the existing methods, such as using a sensor.

In this embodiment, the currently run application may be multiple run applications, wherein the screen may just display one run application and corresponding information, while other applications are run in background; or the screen may display multiple run applications and corresponding information in different regions; or there may be multiple screens on which different run applications are displayed.

As for the situation where the screen just displays one run application and corresponding information, while other applications are run in background, the display control unit 101 may control the operation options corresponding to the run application displayed on the screen.

As for the situation where the screen displays multiple run applications and corresponding information in different regions, the display control unit 101 may control to display the operation options corresponding to one or more of the run applications in response to the user's instruction. For example, when the user performs a predetermined operation on one or more regions, operation options corresponding to the run application displayed in each region is displayed respectively.

As for the situation where there are multiple screens, the display control unit 101 also may control to display the operation options corresponding to the run applications in one or more of the screens in response to the user's instruction. For example, when the user performs a predetermined operation on one or more of the screens, the operation option corresponding to the run application in each screen is displayed in the screen respectively.

In this embodiment, the processing unit 102 processes the currently displayed information in response to the selected operation option, to acquire the information related to the currently displayed information. Wherein, the selected operation option refers to an operation option selected by the user after he or she views the displayed operation options corresponding to the application, in order to acquire the required information.

In this embodiment, the user may adopt any of the existing methods to select the operation option, for example selecting by touching an area of the operation option on the screen, or by means of speech input.

In this embodiment, the processing unit 102 may adopt any of the existing methods to process the currently displayed information to acquire the information related to the currently displayed information. Next, the structure of the processing unit and the method for processing the currently displayed information in this embodiment will be exemplarily described.

FIG. 2 is a structure diagram of a processing unit according to this embodiment. As illustrated in FIG. 2, the processing unit 102 includes a linking unit 201 and a receiving unit 202, wherein:

the linking unit 201 is configured to link currently displayed information into a network; and

the receiving unit 202 is configured to receive information related to the currently displayed information from the network.

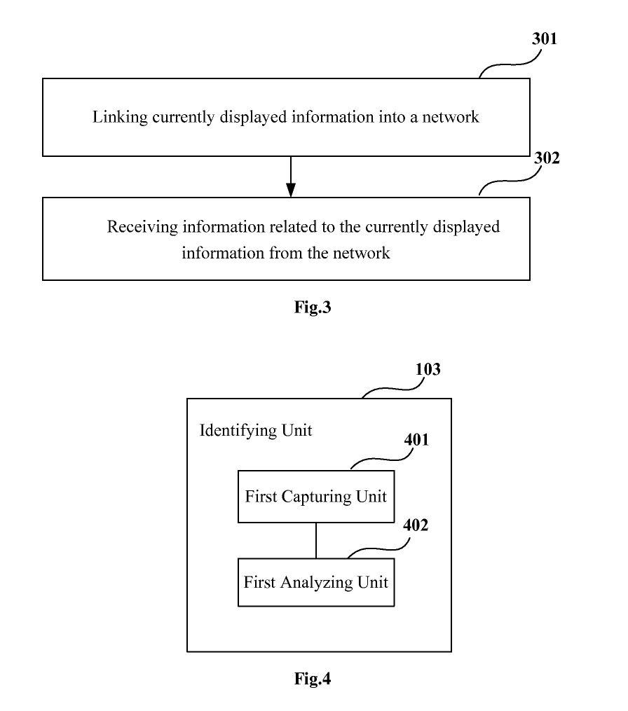

FIG. 3 is a flowchart of a method for processing the currently displayed information by the processing unit according to this embodiment. As illustrated in FIG. 3, the method includes:

Step 301: linking currently displayed information into a network; and

Step 302: receiving information related to the currently displayed information from the network.

Related information of large amount can be acquired by linking the currently displayed information into the network for relevant processing.

In this embodiment, any of the existing methods may be adopted to link the currently displayed information into the network. The network, for example, may be a search engine such as Baidu, Google or Wikipedia, or a cloud server or a terminal equipment.

In this embodiment, after linking the currently displayed information into the network, the linking unit 201 may further start functions required to acquire the related information. For example, after the currently displayed information is linked into the search engine, corresponding search function may be further started to acquire the related information.

For example, in a case where the currently run application is a multimedia player, the currently displayed information is a song name or a singer name. If the operation option selected by the user is “information of singer”, the singer name may be linked into the search engine such as Baidu, Google or Wikipedia to perform a search, and related search result is received to acquire the information of the singer.

For example, in a case where the currently run application is a short message, the currently displayed information is the text content of the short message. If the text content includes English content and the operation option selected by the user is “translate”, the text content may be linked into Baidu Translation or Google Translation, and the translation result is received to acquire the text content translated into Chinese.

For example, in a case where the currently run application is a phone book, the currently displayed information may be a name and a phone number stored in the phone book. If the operation option selected by the user is “search”, the name and the phone number may be linked to the search engine such as Baidu, Google or Wikipedia to perform a search, and related search result is received to acquire related information of the name and the phone number.

In this embodiment, the processing unit 102 also may acquire the information related to the currently displayed information without linking it into the network for a search. For example, corresponding processing may be performed locally.

For example, in a case where the currently run application is a phone book, the currently displayed information may be a name and a phone number stored in the phone book. If the operation option selected by the user is “call record” or “short message record”, call records or short message records related to the name and the phone number may be searched for locally, and those records may be gathered for being viewed by the user.

In this embodiment, the information acquiring apparatus may further include an identifying unit 103 configured to identify the currently displayed information and the currently run application.

In this embodiment, the identifying unit 103 is optional and indicated by a dotted block in FIG. 1.

The current application and information can be accurately acquired by disposing the identifying unit for identifying the currently displayed information and the currently run application, so as to provide targeted related information.

In this embodiment, the identifying unit 103 may adopt any of the existing methods to identify the currently displayed information and the currently run application. Next, the structure of the identifying unit and the method for identifying the currently displayed information and the currently run application in this embodiment will be exemplarily described.

FIG. 4 is a structure diagram of an identifying unit 103 according to this embodiment. As illustrated in FIG. 4, the identifying unit 103 includes a first capturing unit 401 and a first analyzing unit 402, wherein:

the first capturing unit 401 is configured to capture a currently displayed screen in response to a preset instruction; and

the first analyzing unit 402 is configured to acquire the currently displayed information and the currently run application by analyzing the currently displayed screen.

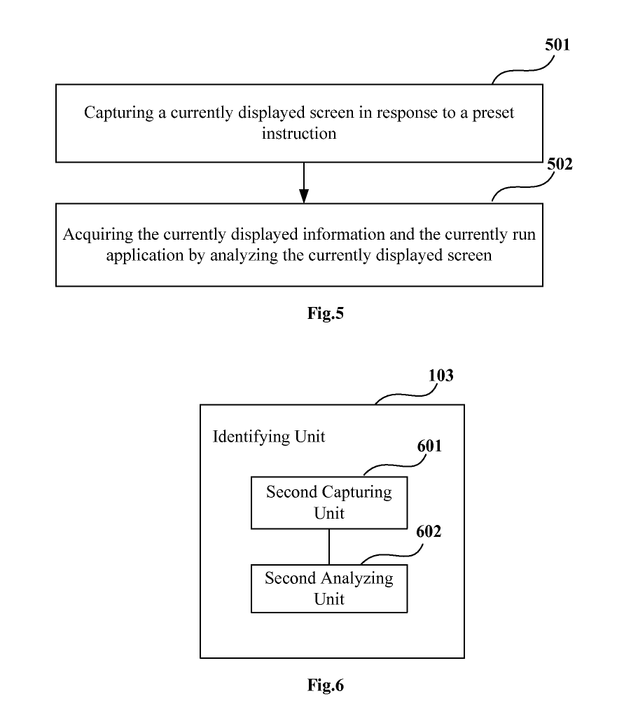

FIG. 5 is a flowchart of a method for identifying the currently displayed information and the currently run application by the identifying unit 103 according to this embodiment. As illustrated in FIG. 5, the method includes:

Step 501: capturing a currently displayed screen in response to a preset instruction; and

Step 502: acquiring the currently displayed information and the currently run application by analyzing the currently displayed screen.

In this embodiment, any of the existing methods may be adopted to capture the currently displayed screen in response to a preset instruction, wherein the preset instruction may be set upon the actual demand. For example, the instruction is a preset action or sound, such as shaking for three times, or inputting a sound of “more information”. The specific type of the preset action or sound and the method for capturing the screen are not limited in embodiments of the present invention.

In this embodiment, any of the existing methods may be adopted to acquire the currently displayed information and the currently run application by analyzing the currently displayed screen. For example, an existing image identifying method may be adopted to identify the name of the application and the text content of the currently displayed information.

The function of acquiring related information can be flexibly invoked by capturing and identifying the screen in response to the preset action or sound.

FIG. 6 is another structure diagram of the identifying unit 103 according to this embodiment. As illustrated in FIG. 6, the identifying unit 103 includes a second capturing unit 601 and a second analyzing unit 602, wherein;

the second capturing unit 601 is configured to monitor a displayed screen, and capture a currently displayed screen when the displayed screen changes; and

the second analyzing unit 602 is configured to acquire the currently displayed information and the currently run application by analyzing the currently displayed screen.

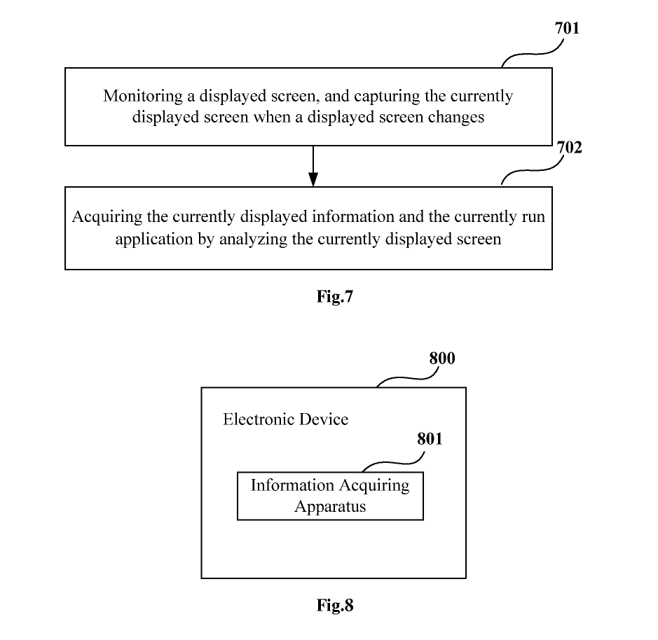

FIG. 7 is another flowchart of a method for identifying the currently displayed information and the currently run application by the identifying unit 103 according to this embodiment. As illustrated in FIG. 7, the method includes:

Step 701: monitoring a displayed screen, and capturing the currently displayed screen when a displayed screen changes; and

Step 702: acquiring the currently displayed information and the currently run application by analyzing the currently displayed screen.

In this embodiment, any of the existing methods may be adopted to monitor and capture the displayed screen.

In this embodiment, any of the existing methods may be adopted to acquire the currently displayed information and the currently run application by analyzing the currently displayed screen. For example, the currently displayed screen is identified by an existing image identifying method.

The function of acquiring related information can be invoked directly and intelligently by monitoring and capturing the displayed screen, without taking any particular activation means. In addition, the capturing is performed only when a change of the screen is monitored, thus the system resources can be saved.

In this embodiment, the information acquiring apparatus may further include an updating unit 104 configured to update the operation options.

In this embodiment, the updating unit 104 is optional and indicated by a dotted block in FIG. 1.

A more targeted operation option can be provided intelligently by updating the operation options.

In this embodiment, the updating unit 104 for example may update the operation options according to a use environment, statistical data or a use habit.

In this embodiment, as for the situation where the operation options are updated according to the use environment, the updating unit 104 may adopt any of the existing methods to detect changes of the use environment. For example, a sensor may be used to detect parameters such as temperature and humidity of an external use environment.

In this embodiment, after changes of the external use environment are detected, the updating unit 104 may update the operation option according to the changed use environment. For example, the user adopts an application related to fitness in a sport, and when the user changes from jogging to swimming, the updating unit 104 detects changes of the use environment, and then updates the operation option to be more related to the swimming for the user's selection.

In this embodiment, as for the situation where the operation option is updated according to the statistical data, for example, frequencies of operation options used by a large number of users may be counted, so as to update the operation options with a higher frequency according to the counting result.

In this embodiment, as for the situation where the operation option is updated according to the use habit, for example, the use habit of the user about the operation options in a period of time may be recorded and analyzed, so as to update the operation options to better meet the use habit of the user, thereby providing personalized services.

As can be seen from the above embodiment, since the operation options are directly provided according to the application, and the information related to the currently displayed information is provided in response to the selected operation option, it is unnecessary to embed plugins into respective applications, thus required information can be acquired simply and conveniently.

### Embodiment 2

The embodiment of the present invention provides an electronic device. FIG. 8 is a structure diagram of an electronic device according to this embodiment. As illustrated in FIG. 8, the electronic device 800 includes an information acquiring apparatus 801, with the same structure and function as Embodiment 1, which is not described herein.

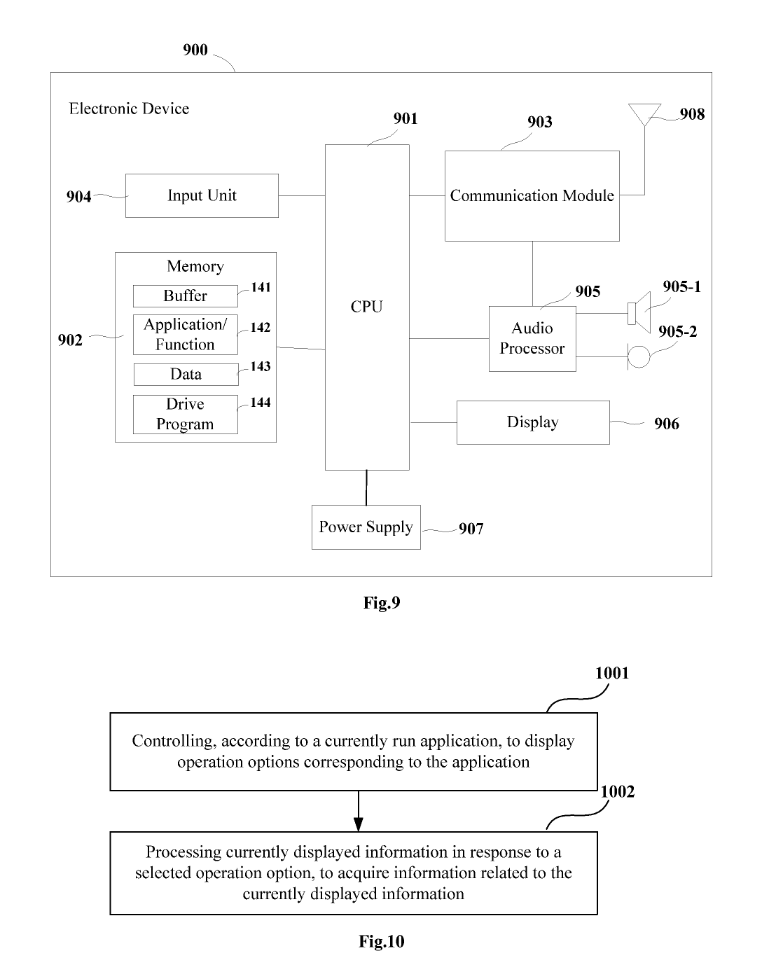

FIG. 9 is a block diagram of a system construction of an electronic device according to this embodiment. As illustrated in FIG. 9, the electronic device 900 may include a Central Processing Unit (CPU) 901 and a memory 902 coupled thereto. To be noted, FIG. 9 is schematic, and other type of structure also may be used to supplement or replace the structure, so as to realize the telecom function or other functions.

In one implementation, the functions of the information acquiring apparatus may be integrated into the CPU 901. The CPU 901 may be configured to control, according to a currently run application, to display operation options corresponding to the application; and process currently displayed information in response to a selected operation option, to acquire information related to the currently displayed information.

The step of processing currently displayed information in response to a selected operation option, to acquire information related to the currently displayed information includes: linking the currently displayed information into a network, and receiving information related to the currently displayed information from the network.

The CPU 901 may be further configured to identify the currently displayed information and the currently run application.

The step of identifying the currently displayed information and the currently run application includes: capturing a currently displayed screen in response to a preset instruction, and acquiring the currently displayed information and the currently run application by analyzing the currently displayed screen.

Or, the step of identifying the currently displayed information and the currently run application includes: monitoring a displayed screen, and capturing a currently displayed screen when the displayed screen changes; and acquiring the currently displayed information and the currently run application by analyzing the currently displayed screen.

The CPU 901 may be further configured to update the operation options.

The step of updating the operation option includes: updating the operation options according to the use environment, the statistical data or the use habit.

In another implementation, the information acquiring apparatus may be disposed separately from the CPU 901. For example, the information acquiring apparatus may be set as a chip connected to the CPU 901, so as to realize the functions of the information acquiring apparatus under the control of the CPU.

As illustrated in FIG. 9, the electronic device 900 may further include a communication module 903, an input unit 904, an audio processor 905, a speaker 905-1, a microphone 905-2, a display 906, a power supply 907 and an antenna 908. To be noted, the electronic device 900 does not necessarily include all the parts as illustrated in FIG. 9. In addition, the electronic device 900 also may include parts not illustrated in FIG. 9, please refer to the prior art.

As illustrated in FIG. 9, the CPU 901 sometimes is called a controller or operation control, including microprocessor or other processor device and logic device. The CPU 901 receives an input and controls the operations on respective parts of the electronic device 900.

The memory 902, for example, may be one or more of buffer, flash memory, hard drive, removable medium, volatile memory, nonvolatile memory or other appropriate apparatus. The memory 902 can store the information related to the operation options, and the program for executing related information. In addition, the CPU 901 may execute the program stored in the memory 902 to realize information storage or processing. The functions of other parts are similar to those in the prior art, and herein are omitted. The parts of the electronic device 900 may be implanted by dedicated hardware, firmware, software or combinations thereof, without deviating from the scope of the present invention.

As can be seen from the above embodiment, since the operation options are directly provided according to the application, and the information related to the currently displayed information is provided in response to the selected operation option, it is unnecessary to embed plugins into respective applications, thus required information can be acquired simply and conveniently.

### Embodiment 3

The embodiment of the present invention further provides an information acquiring method. Since the method solves problems in a principle similar to the functions of the components of the information acquiring apparatus according to Embodiment 1, its specific implementation may refer to that of the information acquiring apparatus according to Embodiment 1, and the same content is omitted herein.

FIG. 10 is a flowchart of an information acquiring method according to this embodiment. As illustrated in FIG. 10, the method includes:

Step 1001: controlling, according to a currently run application, to display operation options corresponding to the application; and

Step 1002: processing currently displayed information in response to a selected operation option, to acquire information related to the currently displayed information.

In this embodiment, the method for acquiring the currently run application and the currently displayed information, the method for controlling to display the operation options corresponding to the application, and the method for processing the currently displayed information to acquire the information related to the currently displayed information are the same as those described in Embodiment 1, and herein are omitted.

As can be seen from the above embodiment, since the operation options are directly provided according to the application, and the information related to the currently displayed information is provided in response to the selected operation option, it is unnecessary to embed plugins into respective applications, thus required information can be acquired simply and conveniently.

The above apparatus and method of the present invention can be implemented by hardware, or a combination of hardware and software. The present invention relates to such a computer readable program, which when being executed by a logical part, enables the logical part to implement the aforementioned apparatus or components or the aforementioned method or steps.

The present invention further relates to a storage medium for storing the above programs, such as hard disk, magnetic disk, optical disk, DVD, flash memory, etc.

The present invention is described as above through the specific embodiments. But a person skilled in the art shall be appreciated that those descriptions are exemplary, rather than limitations to the protection scope of the present invention. According to the spirit and principle of the present invention, a person skilled in the art can make various modifications and amendments which also fall within the scope of the present invention.

1. An information acquiring apparatus, comprising:
a display control unit configured to control, according to a currently run application, to display operation options corresponding to the application; and
a processing unit configured to process currently displayed information in response to a selected operation option, to acquire information related to the currently displayed information.

2. The information acquiring apparatus according to claim 1, further comprising:
an identifying unit configured to identify the currently displayed information and the currently run application.

3. The information acquiring apparatus according to claim 2, wherein the identifying unit comprises:
a first capturing unit configured to capture a currently displayed screen in response to a preset instruction; and
a first analyzing unit configured to acquire the currently displayed information and the currently run application by analyzing the currently displayed screen.

4. The information acquiring apparatus according to claim 2, wherein the identifying unit comprises:
a second capturing unit configured to monitor a displayed screen, and capture a currently displayed screen when the displayed screen changes; and
a second analyzing unit configured to acquire the currently displayed information and the currently run application by analyzing the currently displayed screen.

5. The information acquiring apparatus according to claim 1, wherein the processing unit comprises:
a linking unit configured to link the currently displayed information into a network; and
a receiving unit configured to receive information related to the currently displayed information from the network.

6. The information acquiring apparatus according to claim 1, further comprising:
an updating unit configured to update the operation options.

7. The information acquiring apparatus according to claim 6, wherein,
the updating unit is configured to update the operation options according to a use environment, statistical data or a use habit.

8. An electronic device, comprising an information acquiring apparatus according to claim 1.

9. An information acquiring method, comprising:
controlling, according to a currently run application, to display operation options corresponding to the application; and
processing currently displayed information in response to a selected operation option, to acquire information related to the currently displayed information.

10. The information acquiring method according to claim 9, further comprising:
identifying the currently displayed information and the currently run application.

11. The information acquiring method according to claim 10, wherein identifying the currently displayed information and the currently run application comprises:
capturing a currently displayed screen in response to a preset instruction; and
acquiring the currently displayed information and the currently run application by analyzing the currently displayed screen.

12. The information acquiring method according to claim 10, wherein identifying the currently displayed information and the currently run application comprises:
monitoring a displayed screen, and capturing a currently displayed screen when the displayed screen changes; and
acquiring the currently displayed information and the currently run application by analyzing the currently displayed screen.

13. The information acquiring method according to claim 9, wherein processing currently displayed information in response to a selected operation option, to acquire information related to the currently displayed information comprises:
linking the currently displayed information into a network; and
receiving information related to the currently displayed information from the network.

14. The information acquiring method according to claim 9, further comprising:
updating the operation options.

15. The information acquiring method according to claim 14, wherein
updating the operation option comprises: updating the operation options according to a use environment, statistical data or a use habit.
